(19) United States
(12) Patent Application Publication
(10) Pub. No.: US 2023/0142688 A1
(43) Pub. Date: May 11, 2023

(54) METHOD AND APPARATUS OF ENHANCED RE-ESTABLISHMENT INITIALIZATION IN A COMMUNICATION SYSTEM

(71) Applicant: Lenovo (Beijing) Ltd., Beijing (CN)

(72) Inventors: Lianhai Wu, Beijing (CN); Ran Yue, Beijing (CN); Jie Shi, Beijing (CN); Jing Han, Beijing (CN); Jie Hu, Beijing (CN)

(73) Assignee: Lenovo (Beijing) Ltd., Beijing (CN)

(21) Appl. No.: 17/918,495

(22) PCT Filed: Apr. 17, 2020
(86) PCT No.: PCT/CN2020/085401

§ 371 Date: Oct. 12, 2022

(51) Int. Cl. H04W 76/19

(52) U.S. Cl. CPC H04W 76/19

(57) ABSTRACT

Embodiments of the present application are directed to a method and apparatus of enhanced re-establishment initialization in a communication system. A method for wireless communication performed by a user equipment (UE) or IAB MT is disclosed, wherein the method includes: initiating a re-establishment procedure when neither a master cell group (MCG) link between the UE and a master node (MN) nor a secondary cell group (SCG) link between the UE and a secondary node (SN) is available.

### TECHNICAL FIELD

The present application generally relates to wireless communication technology, and especially to an enhanced re-establishment initialization method in a communication system.

### BACKGROUND

The wireless communications network has grown rapidly over the years. The next generation wireless communication system 5G is an example of an emerging telecommunication standard. 5G, or new radio (NR) networks are expected to increase throughput, coverage, and robustness and reduce latency and operational and capital expenditures. In general, NR is a set of enhancements to the Long Term Evolution (LTE) mobile standard promulgated by the 3rd Generation Partnership Project (3GPP).

With the development of the 5G system, various aspects need to be studied and developed to perfect the 5G NR technology.

### SUMMARY OF THE APPLICATION

Embodiments of the present application provide a method and apparatus of enhanced re-establishment initialization in a communication system.

An embodiment of the present application provides a method for wireless communication performed by a user equipment (UE), wherein the method includes: initiating a re-establishment procedure when neither a master cell group (MCG) link between the UE and a master node (MN) nor a secondary cell group (SCG) link between the UE and a secondary node (SN) is available.

An embodiment of the present application provides a method for wireless communication performed by a user equipment (UE), wherein the method includes: receiving at least one indication from a parent node configured with a fast MCG link recovery function.

Another embodiment of the present application provides an apparatus, wherein the apparatus includes: at least one non-transitory computer-readable medium having computer executable instructions stored therein; at least one receiver; at least one transmitter; and at least one processor coupled to the at least one non-transitory computer-readable medium, the at least one receiver and the at least one transmitter; wherein the computer executable instructions are programmed to implement a method with the at least one receiver, the at least one transmitter and the at least one processor, wherein the method includes: initiating a re-establishment procedure when neither a MCG link between the apparatus and a MN nor an SCG link between the apparatus and an SN is available.

Another embodiment of the present application provides an apparatus, wherein the apparatus includes: at least one non-transitory computer-readable medium having computer executable instructions stored therein; at least one receiver; at least one transmitter; and at least one processor coupled to the at least one non-transitory computer-readable medium, the at least one receiver and the at least one transmitter; wherein the computer executable instructions are programmed to implement a method with the at least one receiver, the at least one transmitter and the at least one processor, wherein the method includes: receiving at least one indication from a parent node configured with a fast MCG link recovery function.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an example of a wireless communication system to which the present application can be applied.

FIG. 2 illustrates a Dual Connectivity (DC) system to which the present application can be applied.

FIG. 3 illustrates an Integrated Access and Backhaul (IAB) system to which the present application can be applied.

FIG. 4 illustrates an IAB NR DC system to which the present application can be applied.

FIG. 5 illustrates an exemplary flow chart in accordance with some embodiments of the present application.

FIG. 6 illustrates an exemplary procedure according to some embodiments of the present disclosure.

FIG. 7 illustrates an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates an example of a wireless communication system to which the present application can be applied.

As illustrated and shown in FIG. 1, a wireless communication system 100 includes at least one user equipment (UE) 101 and at least one base station (BS) 102. In particular, the wireless communication system 100 includes one UE 101 (e.g., UE 101a) and three BSs 102 (e.g., BS 102a, BS 102b, and BS 102c) for illustrative purpose. Although a specific number of UEs 101 and BSs 102 are depicted in FIG. 1, it is contemplated that any number of UEs 101 and BSs 102 may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like. According to some embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate directly with BSs 102 via uplink (UL) communication signals.

In some embodiments of the present application, each of the UE(s) 101 may be deployed an IoT application, an eMBB application and/or an URLLC application. It is contemplated that the specific type of application(s) deployed in the UE(s) 101 may be varied and not limited.

The BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, an NG-RAN (Next Generation-Radio Access Network) node, a Home Node-B, a relay node, or a device, or described using other terminology used in the art. The BS(s) 102 is generally a part of a radio access network that may include one or more controllers communicably coupled to one or more corresponding BS(s) 102. BS(s) 102 may communicate directly with each other. For example, BS(s) 102 may communicate directly with each other via Xn interface or X2 interface.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the DL and the UE(s) 101 transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, the BS(s) 102 may communicate using other communication protocols, such as the IEEE 802.11 family of wireless communication protocols. Further, in some embodiments of the present application, the BS(s) 102 may communicate over licensed spectrums, whereas in other embodiments, the BS(s) 102 may communicate over unlicensed spectrums. The present application is not intended to be limited to the implementation of any particular wireless communication system architecture or protocol. In yet some embodiments of present application, the BS(s) 102 may communicate with the UE(s) 101 using the 3GPP 5G protocols.

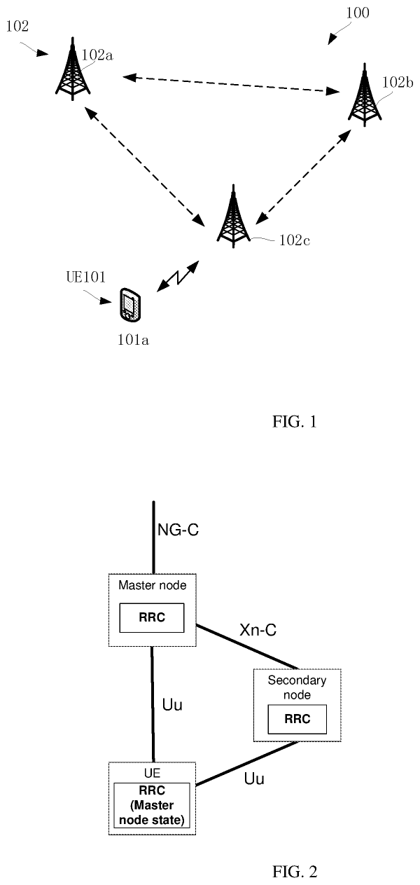

FIG. 2 illustrates a DC system to which the present application can be applied.

NG-RAN supports Multi-Radio Dual Connectivity (MR-DC) operation whereby a UE in RRC_CONNECTED is configured to utilize radio resources provided by two distinct schedulers, located in two different NG-RAN nodes connected via a non-ideal backhaul, one providing NR access and the other one providing either E-UTRA or NR access.

In MR-DC, a multiple Rx/Tx capable UE may be configured to utilize resources provided by two different nodes connected via non-ideal backhaul, one providing NR access and the other one providing either E-UTRA or NR access. One node acts as the Master node (MN) and the other as the Secondary node (SN). The MN and SN are connected via a network interface and at least the MN is connected to the core network.

A Secondary Cell Group (SCG) recovery procedure is proposed in MR-DC. If SCG failure is detected, the UE reports SCG Failure Information message to MN. And, UE does not initiate re-establishment instead. The MN handles the SCG Failure Information message and may decide to keep, change, or release the SN/SCG.

A UE may initiate the procedure to report SCG failures when one of the following conditions is met: upon detecting radio link failure for the SCG; upon reconfiguration with sync failure of the SCG; upon SCG configuration failure; upon integrity check failure indication from SCG lower layers concerning SRB3 (Signaling Radio Bearer type 3).

A fast Master Cell Group (MCG) link recovery procedure is proposed in MR-DC. The purpose of this procedure is to inform NR MN about an MCG link failure via SCG link. A UE configured with split SRB1 (Signaling Radio Bearer type 1) or SRB3 initiates the procedure to report MCG failures when radio link failure (RLF) in MCG link happens. If SRB1 is configured as split SRB, the UE shall start timer (e.g. T316) and submit the MCGFailureInformation message to lower layers for transmission via SRB1. If SRB3 is configured, submit the MCGFailureInformation message to lower layers for transmission embedded in NR RRC message ULInformationTransferMRDC via SRB3.

After MCG receives the MCG failure indication, one of the reconfiguration of sync and release message will be transmitted to UE. A new RRC message, i.e., DLInformationTransferMRDC, is introduced in order to allow the SN to encapsulate (for SRB3) the MN response (i.e., RRCReconfiguration or RRCRelease message) to be send to the UE.

The UE may set the MCG failure type as different types. For example, if the UE initiates transmission of the MCGFailureInformation message due to T310 expiry, UE sets the failureType as t310-Expiry. If the UE initiates transmission of the MCGFailureInformation message to provide random access problem indication from MCG MAC, UE sets the failureType as randomAccessProblem. If the UE initiates transmission of the MCGFailureInformation message to provide indication from MCG RLC that the maximum number of retransmissions has been reached, UE sets the failureType as rlc-MaxNumRetx.

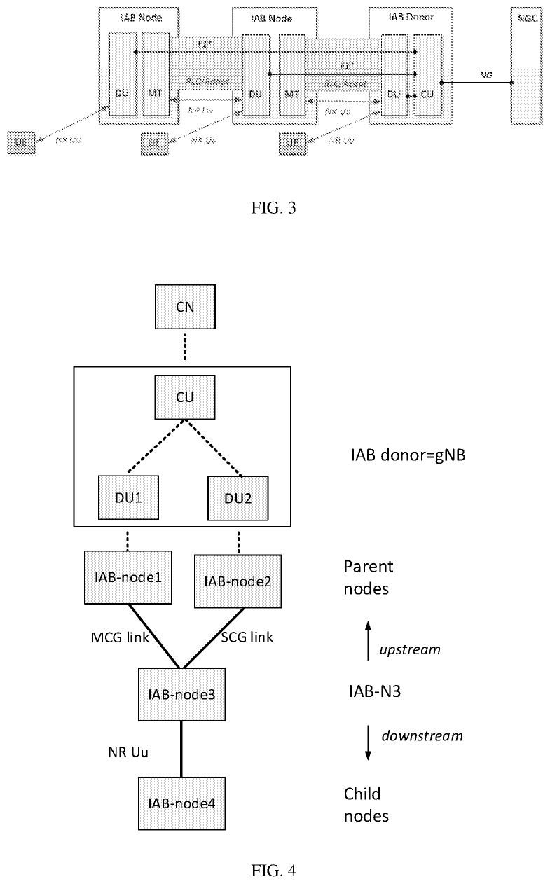

FIG. 3 illustrates an IAB system to which the present application can be applied.

As shown in FIG. 3, IAB enables wireless relaying in NG-RAN. The relaying node, referred to as IAB-node, supports access and backhauling via NR. The terminating node of NR backhauling on network side is referred to as the IAB-donor, which represents a gNB with additional functionality to support IAB. A UE is connected to donor node relayed by several IAB nodes.

IAB node may include Mobile-Termination (MT) and Distributed Unit (DU). The IAB-node supports gNB-DU functionality, as defined in TS 38.401, to terminate the NR access interface to UEs and next-hop IAB-nodes, and to terminate the F1 protocol to the gNB-CU functionality, as defined in TS 38.401, on the IAB-donor. The IAB-node DU is also referred to as IAB-DU.

In addition to the gNB-DU functionality, the IAB-node also supports a subset of the UE functionality referred to as IAB-MT, which includes, e.g., physical layer, layer-2, RRC and NAS functionality to connect to the gNB-DU of another IAB-node or the IAB-donor, and to connect to the gNB-CU on the IAB-donor.

FIG. 4 illustrates an IAB NR DC system to which the present application can be applied.

A backhauling can occur via a single or multiple hops. In Multi-hop backhauling, IAB node may have a plurality of active routes to the donor BS via multiple parent IAB nodes as shown in FIG. 4. Multi-hop backhauling provides more range extension than single hop. This is especially beneficial for above-6 GHz frequencies due to their limited range. Multi-hop backhauling further enables backhauling around obstacles, e.g. buildings in urban environment for in-clutter deployments.

In IAB system, all IAB-nodes that are connected to an IAB-donor via one or multiple hops form a directed acyclic graph (DAG) topology with the IAB-donor at its root. In this DAG topology, the neighbour node on the IAB-DU's interface is referred to as child node and the neighbour node on the IAB-MT's interface is referred to as parent node (see FIG. 4). The direction toward the child node is further referred to as downstream while the direction toward the parent node is referred to as upstream (see FIG. 4).

In existing DC system as shown in FIG. 2, re-establishment may be initiated once RLF on MCG link happens. If re-establishment of link fails on MCG, UE enters idle mode even if SCG link is still available. However, it is unnecessary for IAB node to enter into the idle mode if only one of two parent nodes fails in IAB DC system. For example, in the IAB NR DC system as shown in FIG. 4, IAB-node3 accesses gNB CU via NR-DC. IAB-node1 and IAB-node2 together with gNB CU are configured as MCG link and SCG link for IAB-node3, respectively. In fact, IAB-node3 accesses one common gNB CU. From IAB-node3 point of view, IAB-node1 and IAB-node2 are just two ‘paths’. When one of IAB-node1 and IAB-node2 fails, IAB-node3 can still route the data via another path. It is unnecessary for IAB-node3 to enter the idle mode unless both IAB1 and IAB2 fail.

In light of the above, an enhanced re-establishment initialization method is proposed.

According to a first embodiment of the present application, when fast MCG link recovery is configured, once RLF happens to the MCG link, the UE may report MCGFailureInformation message to the MN via the SN and start a timer, T316. If the UE receives the response from the MN via the SN, the UE stops the T316. Once the T316 expires, re-establishment does not need to be initiated if SCG link is still available, since data may still be transmitted via SCG link.

In other words, the UE may initiate re-establishment procedure only if both MCG link and SCG link fail, e.g. due to RLF, for example, when the UE operates as IAB MT. That is, the UE does not initiate re-establishment even when the T316 expires as long as the SCG link is available, and there is no need for the UE to stop data transmission. The UE only initiate re-establishment procedure when the T316 expires and SCG link is not available, or both the MCG link and SCG link are not available, for example, due to RLF.

When the T316 expiry, the UE may keep detecting or monitoring a channel quality of the MCG link for determining whether the MCG is back for available. Once the SCG link goes to fail, for example, RLF is detected for SCG link, and the MCG link is still not available, the UE initiates re-establishment procedure.

In some embodiments, the T316 may be set to infinity so that the T316 never expires. In other words, the MN may get the report from UE and the T316 will not expire. When the T316 is running and SCG link is not available, the UE initiates re-establishment.

In existing procedures, when re-establishment on MCG link fails, the UE may report RLF notification to its child node(s) regardless of SCG link is available or not. However, it is unnecessary to transmit RLF if one of MCG link and SCG link is available and stop data transmission. Various situations for sending indications from the UE to the child node(s) are described in the following according to some embodiments of the present application.

In some embodiments, indications ‘be about to fail’, ‘T316 is started’, or ‘T316 is running’ may be sent to child node to inform the child nodes in the case that fast MCG link recovery is configured. When UE receives this information, UE may perform re-establishment or stop data transmission.

In some embodiments, RLF notification may be sent to child node if T316 is running and RLF is detected for SCG link. Such reporting is suitable for the case that infinity or finite value is configured;

In some embodiments, RLF notification may be sent to child node only if both MCG and SCG link are not available e.g. due to RLF. Such reporting is suitable for the case that one IAB node has more than one MT besides normal case.

In some embodiments, RLF notification may be sent to child node if T316 expiries and RLF is detected for SCG link. Such reporting is suitable for non-infinity is configured.

In some embodiments, RLF notification may be sent to child node only if IAB MT enters idle mode or inactive mode.

According to a second embodiment of the present application, when fast MCG link recovery is not configured, once RLF happens for MCG, the UE may not initiates re-establishment. In some embodiments, the UE, for example, operating as IAB MT, may initiate re-establishment procedure if RLF is detected for both the MCG link and SCG link. That is, Re-establishment may not be initiated if RLF happens on the MCG link and SCG link is available, or re-establishment may not be initiated if one of the MCG link and SCG link is available. The UE may initiate re-establishment only if both the MCG link and SCG link are not available e.g. due to RLF.

The UE may keep detecting or monitoring a channel quality of the MCG link for determining whether the MCG is back for available. Once the SCG link goes to fail, for example, RLF is detected for SCG link, and the MCG link is still not available, the UE initiates re-establishment procedure.

When the UE fails to perform re-establishment procedure, the UE may need to indicate RLF notification to its child node(s). When the child node receives the RLF notification, the child node may perform reestablishment.

In some embodiments, RLF notification may be sent to child node only if both the MCG link and SCG link are not available e.g. due to RLF.

In some embodiments, RLF notification may be sent to child node only when the UE enters idle mode or inactive mode.

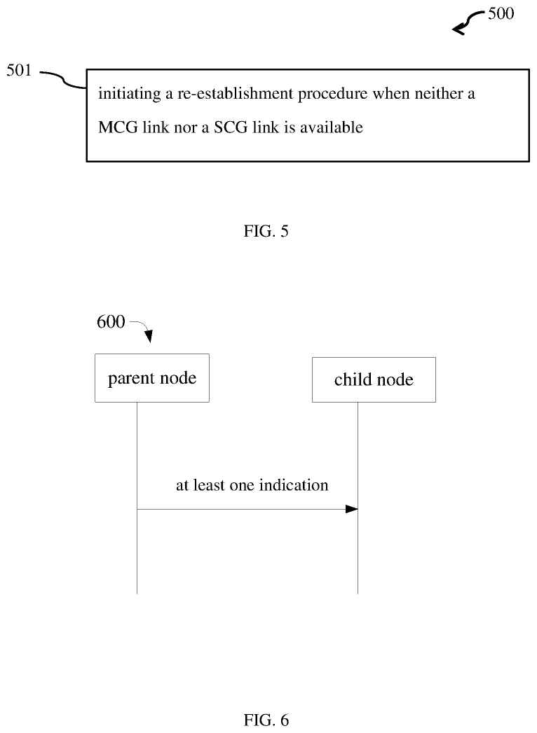

FIG. 5 is an exemplary flow chart 500 showing an enhanced re-establishment initialization in accordance with some embodiments of the present application. In step 501, a UE initiates a re-establishment procedure only when neither a MCG link nor an SCG link is available. That is, if one of a MCG link and an SCG link is available, the UE will not initiate a re-establishment procedure.

FIG. 6 illustrates an exemplary procedure 600 according to some embodiments of the present disclosure. As shown in FIG. 6, a child node may receive at least one indication from the parent node. The parent node may be configured with a fast MCG link recovery function. In some embodiments, the at least one indication includes at least one of the following: a first indication of ‘be about to fail’ indicating the MCG link fails and the SCG link is available for the parent node, a second indication of ‘timer is started’ indicating a MCG link recovery timer starts, and a third indication of ‘the timer is running’ indicating a MCG link recovery timer is running.

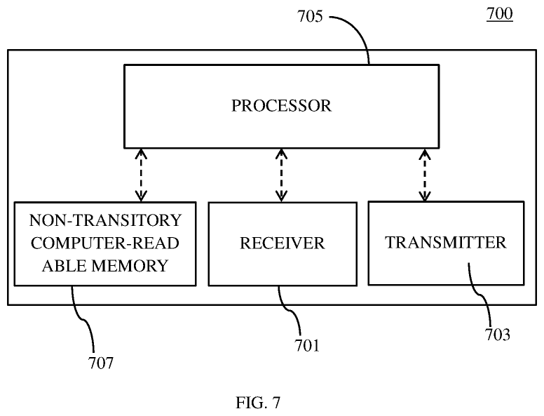

FIG. 7 illustrates an apparatus according to some embodiments of the present application. In some embodiments of the present disclosure, the apparatus 700 may be UE 101a illustrated in FIG. 1, the UE and/or MT in FIGS. 2 and 3, the IAB-node 3 in FIG. 4, and/or the child node in FIG. 6.

As shown in FIG. 7, the apparatus 700 may include a receiver 701, a transmitter 703, a processer 705, and a non-transitory computer-readable medium 707. The non-transitory computer-readable medium 707 has computer executable instructions stored therein. The processer 705 is configured to be coupled to the non-transitory computer readable medium 707, the receiver 701, and the transmitter 703. It is contemplated that the apparatus 700 may include more computer-readable mediums, receiver, transmitter and processors in some other embodiments of the present application according to practical requirements. In some embodiments of the present application, the receiver 701 and the transmitter 703 are integrated into a single device, such as a transceiver. In certain embodiments, the apparatus 700 may further include an input device, a memory, and/or other components.

In some embodiments of the present application, the non-transitory computer-readable medium 707 may have stored thereon computer-executable instructions to cause a processor to implement the above methods according to embodiments of the present application.

Persons skilled in the art should understand that as the technology develops and advances, the terminologies described in the present application may change, and should not affect or limit the principle and spirit of the present application.

Those having ordinary skill in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method for wireless communication performed by a user equipment (UE), the method comprising:
initiating a re-establishment procedure when neither a master cell group (MCG) link between the UE and a master node (MN) nor a secondary cell group (SCG) link between the UE and a secondary node (SN) is available.

2. The method of claim 1, wherein the initiating the re-establishment procedure comprises:
initiating the re-establishment procedure when radio link failure (RLF) is detected in both the MCG link and the SCG link.

3. The method of claim 1, wherein the UE is configured with a fast MCG link recovery function, and the method further comprises:
when radio link failure (RLF) in the MCG link is detected, initiating a fast MCG link recovery procedure by transmitting MCG failure information to the MN via the SN and starting a timer; and
stopping the timer when receiving a response from the MN via the SN.

4. The method of claim 3, wherein at least one of:
the timer is configured as a finite value, and the initiating the re-establishment procedure when the timer expires and the SCG link is not available; or
the timer is configured as infinity, and the initiating the re-establishment procedure when the timer is running and the SCG link is not available.

5-6. (canceled)

7. The method of claim 3, further comprising:
transmitting, to a child node, at least one of:
a first indication of ‘be about to fail’ when the MCG link fails and the SCG link is available;
a second indication of ‘timer is started’ when the timer starts; or
a third indication of ‘the timer is running’ when the timer is running.

8-9. (canceled)

10. The method of claim 3, further comprising:
transmitting a radio link failure (RLF) notification to a child node when the timer is running and failure of the SCG link is detected.

11. The method of claim 1, further comprising:
transmitting a radio link failure (RLF) notification to a child node when both of the MCG link and the SCG link fail.

12. The method of claim 1, further comprising:
transmitting a radio link failure (RLF) notification to a child node when a timer expires and failure of the SCG link is detected.

13. The method of claim 1, further comprising:
performing the re-establishment procedure after the re-establishment procedure is initiated; and
when the re-establishment procedure fails, entering into an idle mode or an inactive mode and transmitting a radio link failure (RLF) notification to a child node.

14-19. (canceled)

20. An apparatus, comprising:
a receiver;
a transmitter; and
a processor coupled to the receiver and the transmitter configured to cause the apparatus to initiate a re-establishment procedure when neither a master cell group (MCG) link between the apparatus and a master node (MN) nor a secondary cell group (SCG) link between the apparatus and a secondary node (SN) is available.

21. The apparatus of claim 20, wherein the processor coupled to the receiver and the transmitter is configured to cause the apparatus to initiate the re-establishment procedure based at least in part on radio link failure (RLF) detected in both the MCG link and the SCG link.

22. The apparatus of claim 20, wherein:
the apparatus is configured with a fast MCG link recovery function; and
the processor coupled to the receiver and the transmitter is configured to cause the apparatus to:
transmit MCG failure information to the MN via the SN and start a timer to initiate a fast MCG link recovery procedure based at least in part on radio link failure (RLF) in the MCG link being detected; and
stop the timer based at least in part on a response received from the MN via the SN.

23. The apparatus of claim 20, wherein the processor coupled to the receiver and the transmitter is configured to cause the apparatus to transmit a radio link failure (RLF) notification to a child node when both of the MCG link and the SCG link fail.

24. The apparatus of claim 20, wherein the processor coupled to the receiver and the transmitter is configured to cause the apparatus to transmit a radio link failure (RLF) notification to a child node when a timer expires and failure of the SCG link is detected.

25. The apparatus of claim 20, wherein the processor coupled to the receiver and the transmitter is configured to cause the apparatus to:
perform the re-establishment procedure after the re-establishment procedure is initiated; and
enter into an idle mode or an inactive mode and transmit a radio link failure (RLF) notification to a child node based at least in part on the re-establishment procedure fails.

26. An apparatus, comprising:
a receiver;
a transmitter; and
a processor coupled to the receiver and the transmitter configured to cause the apparatus to receive at least one indication from a parent node configured with a fast master cell group (MCG) link recovery function.

27. The apparatus of claim 26, wherein the processor coupled to the receiver and the transmitter is configured to cause the apparatus to receive the at least one indication as an about to fail indication when an MCG link fails and a secondary cell group (SCG) link is available for the parent node.

28. The apparatus of claim 26, wherein the processor coupled to the receiver and the transmitter is configured to cause the apparatus to receive the at least one indication as a time is started indication when an MCG link recovery timer starts.

29. The apparatus of claim 26, wherein the processor coupled to the receiver and the transmitter is configured to cause the apparatus to receive the at least one indication as a timer is running indication when an MCG link recovery timer is running.

30. The apparatus of claim 26, wherein the processor coupled to the receiver and the transmitter is configured to cause the apparatus to perform at least one of re-establishment or stopping data transmission based at least in part on receiving the at least one indication.
